(19) United States
(12) Patent Application Publication
(10) Pub. No.: US 2017/0312969 A1
(43) Pub. Date: Nov. 2, 2017

(54) METHOD FOR MANUFACTURING MIXTURE PTFE THREAD AND MIXTURE PTFE THREAD MANUFACTURED BY THE SAME METHOD

(71) Applicant: JAPAN MATEX CO., LTD., Osaka (JP)

(72) Inventors: Katsuro TSUKAMOTO, Osaka (JP); Hiroaki TSUKAMOTO, Osaka (JP)

(21) Appl. No.: 15/140,702

(22) Filed: Apr. 28, 2016

(51) Int. Cl. B29C 47/00; D01F 6/12; B29L 31/00; B29K 27/18; B29K 105/00

(52) U.S. Cl. CPC B29C 47/0059; B29C 47/0016; B29C 47/0004; D01F 6/12; B29K 2027/18; B29K 2105/251; B29L 2031/731; D10B 2321/042; B29K 2995/0077

(57) ABSTRACT

A method of manufacturing a mixture PTFE thread using a mixture PTFE powder consisting of PTFE: 73-95 wt %, MoS₂: 3-25 wt %, Al₂O₃: 1-5 wt %, and Al(OH)₃: 1-5 wt % comprises heat-retaining step for adding 18-25 wt % kerosene of a solvent to the mixture PTFE powder and keeping it warm at 30-50° C. for 40 to 50 hours, extruding the heat-retained mixture PTFE powder into a rod shape with a circular or elliptical cross section at the cylinder temperature of 70-90° C., rolling the extrusion at 100-150° C. into a 0.3-0.7 mm thick sheet shape, multiple-folding the sheet and passing the sheet through an oven at 250-270° C. at the rate of 10-40 cm/s, and stretching the folded sheet with a stretch ratio of 200-600% in multiple stages after heating the sheet at 450-500° C.

### TECHNICAL FIELD

The present invention relates to a method of manufacturing mixture PTFE (polytetrafluoroethylene) thread with excellent tensile strength and a mixture PTFE thread manufactured by the same method.

### BACKGROUND

PTFE is manufactured in the form of twisted yarn, such as tapes and strings, and used as an important material for a gland packing. The gland packing is a sealant for preventing leakage of liquid or gas and is essentially used for various kinds of valves. It is variously used for, in particular, nuclear power plants, factories, petrochemical units, pumps, or the like. A PTFE tape or twisted yarn is mainly used for a packing method where it is stuffed in a stuffing box around an axis to provide a seal on the friction surface between the axis and the packing. The PTFE tape or twisted yarn is used for the gland packing in need of perfect sealing and thus desired to have excellent durability, i.e., tensile strength. Patent Document 1 discloses a method of manufacturing PTFE long fiber by heat-treating a biaxially-stretched film of the PTFE and then longitudinally providing slits in part of the film. This PTFE long twisted yarn corresponds to a mixture PTFE thread in the present invention. “Mixture PTFE thread” herein is used as a term meaning a PTFE composed mainly of PTFE thread but containing other components. GFO® fiber from W.L. Gore & Associates, Inc. manufactured by mixing graphite powder with PTFE powder is also used for gland packing materials. The packing material knitted with pointed fibers has chemical resistance of PTFE and heat resistance of graphite, and thus is used for various kinds of valves, rotary machines, rotary pumps, agitators, flanges or the like.

In addition to the 100% PTFE long fiber disclosed in the patent document 1, GFO® fiber which has been conventionally used for gland packing has a limited tensile strength for durability.

The inventors thought that once a mixture PTFE thread with excellent tensile strength for improving durability of mixed PTFE twisted yarn is developed, it would be used for not only gland packing but also the field of valves for various pumps, timing belts, v belts, various petrochemical units, cars, airplanes, high-speed trains, rockets or the like, and they finally developed the mixture PTFE thread with excellent tensile strength of the present invention.

### PRIOR ART DOCUMENT

### Patent Document

[Patent document 1] Japanese Unexamined Patent Application Publication No. 2004-244787

### SUMMARY

It is an object of the present invention to provide a method of manufacturing a mixture PTFE thread with excellent tensile strength and a mixture PTFE thread with excellent tensile strength used as materials for gland packing, etc., which is manufactured by the same method.

First embodiment of the present invention relates to a method of manufacturing a mixture PTFE thread using a mixture PTFE powder consisting of PTFE: 73-95 wt %, MoS₂: 3-25 wt %, Al₂O₃: 1-5 wt %, and Al(OH)₃: 1-5 wt %, the method comprising heat-retaining step for adding 18-25 wt % kerosene of a solvent to the mixture PTFE powder and keeping it warm at 30-50° C. for 40 to 50 hours (this step provides viscoelasticity to the PTFE powder), extruding the heat-retained mixture PTFE powder into a rod shape with a circular or elliptical cross section at the cylinder temperature of 70-90° C. (the product extruded into the rod shape has a specific gravity of about 1.5), rolling the extrusion at 100-150° C. into a 0.3-0.7 mm thick sheet shape, multiple-folding the sheet and passing the sheet through an oven at 250-270° C. at the rate of 10-40 cm/s (At this folding step, the rolled 300 mm wide sheet is triple-folded and passed through an oven at 250-270° C. at the rate of 10-40 cm/s into a 100 mm wide sheet. Additionally, this folding step can provide uniform tension to the mixture PTFE thread, compared with non-triple folding step. However, the width of the sheet before triple-folding is not limited to 300 mm as described below), and stretching the folded sheet with a stretch ratio of 200-600% in multiple stages after heating the sheet at 450-500° C.

The multistage stretching is preferably a five-stage stretching including first stretching with 120% stretch ratio, second stretching with 50% stretch ratio, third stretching with 60% stretch ratio, fourth stretching with 30% stretch ratio, and fifth stretching with 15% stretch ratio. A brushing step can be added after the five-stage stretching. In the brushing step, many slits are formed in the twisted yarn in a longitudinal direction. The brushing step is also referred to as a slit step or a knife step.

The second embodiment of the present invention is a mixture PTFE thread manufactured by the method of manufacturing a mixture PTFE thread according to the first embodiment, and the mixture PTFE thread has a diameter of 1-3 mm and a weight of 1-10 g/m. The mixture PTFE thread has a network structure where many slits are continuously formed in a longitudinal direction during the brushing step. The network structure can be observed when the mixture PTFE thread is spread in a direction perpendicular to the longitudinal direction. The mixture PTFE thread is generally stretched and then wound in the form of a string due to its own tension. The mixture PTFE thread is cut into 10-30 mm wide tapes and twisted into a mixture PTFE thread.

### Effects of the Invention

The present invention provides a method of manufacturing a mixture PTFE thread with excellent tensile strength used as materials for gland packing etc., and a mixture PTFE thread with excellent tensile strength used as materials for gland packing etc. manufactured by the same manufacturing method.

### BRIEF DESCRIPTION OF DRAWINGS

FIG. 1 shows a comparison table comparing breaking strength of the mixture PTFE thread according to the present invention and the conventional product based on JIS L1013.

### DESCRIPTION OF EMBODIMENTS

### Embodiment 1

Embodiment 1 of the present invention relates to a method of manufacturing a mixture PTFE thread with excellent tensile strength and its manufacturing process is shown below.

(Step I) Heat-Retaining Step

A mixture PTFE powder consisting of PTFE: 73-95 wt %, MoS₂: 3-25 wt %, Al₂O₃: 1-5 wt %, and Al(OH)₃: 1-5 wt % is prepared, 18-25 wt % kerosene of a solvent is added to the mixture PTFE powder consisting of PTFE: 73-95 wt %, MoS₂: 3-25 wt %, Al₂O₃: 1-5 wt %, and Al(OH)₃: 1-5 wt % and kept warm at 30-50° C. for 40 to 50 hours. This heat-retaining step provides viscoelasticity to the mixture PTFE powder.

(Step II) Extrusion Step

The viscoelastic mixed PTFE obtained in the step I (heat-retaining step) is extruded into a rod shape with a circular or elliptical cross section having a diameter of 5-25 mm and a specific gravity of about 1.5 at the cylinder temperature of 70-90° C.

(Step III) Rolling Step

The extrusion obtained in the Step II (the above-mentioned Extrusion Step) is rolled at 100-150° C. into a 300 mm wide and 0.3-0.7 mm thick sheet shape.

(Step IV) Folding Step

The 300 mm wide sheet rolled in the Step III is triple-folded into a 100 mm wide sheet having a three-layer structure. The triple folding is made because the rolling of the extrusion into a sheet does not provide uniform tension on central and peripheral part of the sheet. Therefore, the 300 mm wide sheet is triple-folded and passed through an oven at 250-270° C. at the rate of 10-40 cm/s into a 100 mm wide sheet. This step can provide uniform tension to the mixture PTFE thread, unlike a non-triple folding step. However, the width of the sheet is not limited to 300 mm. For example, if a 240-mm wide sheet is triple-folded, 80 mm wide sheets are obtained, and if a 210 mm wide sheet is triple-folded, 70 mm wide sheets are obtained. In this step under the temperature of 250-270° C., one of crystals (OH) of Al(OH)₃ of the PTFE thread disappears. The number of folding times herein is not limited to triple, but may be preferably multiple, for example, double or quadruple.

Step V) Stretching Step

The sheet triple-folded in the Step IV (Folding Step) is heated in an oven at 450-500° C. and stretched at the rate of 30-100 cm/s with a stretch ratio of 200-600%. The Step V (Stretching step) may be preferably multistage stretching, in particular, five-stage stretching, but the roller temperature in each stage is 100-150° C. In the five-step stretching, the sheet is stretched through a first roller with 120% stretch ratio, through a second roller with 50% stretch ratio, through a third roller with 60% stretch ratio, through a fourth roller with 30% stretch ratio, and then through a fifth roller with 15% stretch ratio. It would be easy to those skilled in the art to achieve such multistage stretching by adjusting the speed of the rollers in each stage. Through this step, Al(OH)₃ loses two of the remaining crystals (OH) to become aluminum oxide. The aluminum oxide binds to PTFE and MoS₂ and this binding is so strong that it plays a big role in excellent tensile strength of the formed mixture PTFE thread. According to this embodiment, the mixture PTFE thread is slit longitudinally due to molecular orientation to form a network structure as the stretching step progresses. The network structure contributes to the improvement of tensile strength. If the stretching step insufficiently provides slits in the slits, a step of brushing the twisted yarn in a longitudinal direction to form additional slits is added. The brushing step is also referred to as a slit step or a knife step, and can be easily achieved by those skilled in the art which the present invention belongs to. In the stretching step of the present invention, the sheet can be uniaxially stretched or biaxially stretched. The uniaxial stretching is as described above. The sheet can also be stretched not only in a longitudinal direction, but also in a width direction, i.e., biaxially stretched. The biaxial stretching can be easily achieved by those skilled in the art. The mixture PTFE thread manufactured by these methods has a diameter of 1-3 mm and a weight of 1-10 g/m.

The method of manufacturing the mixture PTFE powder is described in detail hereinafter.

To PTFE emulsion containing a PTFE solid content of 20 wt % were dispersed MoS₂, Al₂O₃, and Al(OH)₃ in water, with their amounts changing per examples. Then, 0.01 wt % sodium carbonate was added in a dehydration process to form a cake where the PTFE solid content, MoS₂, Al₂O₃, and Al(OH)₃ were well-separated from water. It was then dried at the temperature of 160° C. for 20 hours to afford ingot. The ingot was ground with 30-mesh vibration net to afford mixture PTFE powder. The method of manufacturing mixture PTFE powder is shown in details as below.

Step 1: Water Dispersion Mixing Step

To PTFE emulsion containing a PTFE solid content of 10-25 wt % were dispersed MoS₂, Al₂O₃, and Al(OH)₃, in water. Then, sodium carbonate was added in a dehydration process to form a cake where the PTFE solid content, MoS₂, Al₂O₃, and Al(OH)₃ were well-separated from water. It was then dried at the temperature of 120-190° C. for 16-24 hours to afford ingot. The ingot was ground with 30 to 35-mesh vibration net to afford mixture PTFE powder. The amount of the sodium carbonate added in the dehydration process is preferably about 0.01 wt %. The molecular weight of PTFE in this embodiment is preferably 7,000,000-30,000,000 mol, MoS₂ has preferably a purity of 99.5 wt % or more and a particle size of 1.4 μm±50% or more, Al₂O₃ has preferably a purity of 99.6 wt % or more and a particle size of 1 μm±50% or more, and Al(OH)₃ has preferably a purity of 99 wt % or more and a particle size of 1 μm±50% or more. These are dispersed and mixed in water and mixed at normal temperature and then stirred after 0.01 wt % sodium carbonate is added thereto. Sodium carbonate allows the PTFE solid content, MoS₂, Al₂O₃, and Al(OH)₃ to be well-separated from water and the PTFE mixture will become a cake. This is dried at the temperature of 120-190° C. for 16 to 24 hours to afford ingot. The ingot is ground with a 30 to 35-mesh vibration net so as to have a particle size of 400 to 500 μm±20% to afford a mixture PTFE powder.

Step 2: Drying Step

The mixture PTFE powder obtained at the step 1 can pass through a drying step in the shape of a rod, prior to the heat-retaining step. The drying step maintains the mixture PTFE powder at a low temperature of 1-3° C. for 20-30 hours to keep the water content 0.03 wt % or less through the condensation. This step can be performed if necessary.

### EXAMPLE

The method of manufacturing the mixture PTFE thread using the mixture PTFE powder and the mixture PTFE thread manufactured by the manufacturing method will be set forth in details based on the following examples. The examples, however, are provided only for illustrating the present invention and do not limit the scope of the invention.

### Examples 1-7

Composition of the mixture PTFE powder is shown in Table 1.

TABLE 1
(wt %)

| | PTFE | MoS₂ | Al₂O₃ | Al(OH)₃ |
|---|---|---|---|---|
| Example 1 | 83 | 15 | 1 | 1 |
| Example 2 | 73 | 21 | 3 | 3 |
| Example 3 | 95 | 3 | 1 | 1 |
| Example 4 | 91 | 3 | 3 | 3 |
| Example 5 | 73 | 25 | 1 | 1 |
| Example 6 | 88 | 11 | 5 | 1 |
| Example 7 | 83 | 11 | 1 | 5 |
| Comparative Example 1 | 85 | 15 | 0 | 0 |
| Comparative Example 2 | 82 | 15 | 3 | 0 |
| Comparative Example 3 | 75 | 15 | 10 | 0 |
| Comparative Example 4 | 81 | 15 | 0 | 4 |
| Comparative Example 5 | 75 | 15 | 0 | 10 |
| Comparative Example 6 | 96 | 3 | 1 | 0 |
| Comparative Example 7 | 93 | 1 | 3 | 3 |
| Comparative Example 8 | 71 | 27 | 1 | 1 |
| Comparative Example 9 | 65 | 25 | 5 | 5 |
| Comparative Example 10 | 83 | 15 | 1 | 1 |
| Comparative Example 11 | 83 | 15 | 1 | 1 |
| Comparative Example 12 | 83 | 15 | 1 | 1 |
| Comparative Example 13 | 78 | 20 | 1 | 1 |
| Comparative Example 14 | 73 | 25 | 1 | 1 |

These mixture PTFE powders were used to manufacture a mixture PTFE thread in the following steps. The tensile strength of the manufactured mixture PTFE thread is shown in Table 2.

TABLE 2

| | | Cross sectional | Tensile |
|---|---|---|---|
| | Diameter | Area | Strength |
| | (mm) | (mm²) | (Mpa) |
| Example 1 | 2 | 3.14 | 93.1 |
| Example 2 | 2 | 3.14 | 90.2 |
| Example 3 | 2 | 3.14 | 86.3 |
| Example 4 | 2 | 3.14 | 87.8 |
| Example 5 | 2 | 3.14 | 88.2 |
| Example 6 | 2 | 3.14 | 86.6 |
| Example 7 | 2 | 3.14 | 88.3 |
| Example 8 | 2 | 3.14 | 92.8 |
| Example 9 | 2 | 3.14 | 87.6 |
| Comparative Example 1 | 2 | 3.14 | 10.6 |
| Comparative Example 2 | 2 | 3.14 | 41.3 |
| Comparative Example 3 | 2 | 3.14 | 76.9 |
| Comparative Example 4 | 2 | 3.14 | 58.2 |
| Comparative Example 5 | 2 | 3.14 | 78.8 |
| Comparative Example 6 | 2 | 3.14 | 19.8 |
| Comparative Example 7 | 2 | 3.14 | 87.6 |
| Comparative Example 8 | 2 | 3.14 | 56.8 |
| Comparative Example 9 | 2 | 3.14 | 86.8 |
| Comparative Example 10 | 2 | 3.14 | 76.9 |
| Comparative Example 11 | 2 | 3.14 | 89.2 |

AG-10KNG of Shimadzu was used for tensile strength under the conditions of a distance between chucks: 200 mm and tension rate: 200 mm/min according to JIS-L-1013.

Heat-Retaining Step

20 wt % kerosene of a solvent was added to a mixture PTFE powder and kept warm at 40° C. for 45 hours.

Extrusion Step

After this heat-retaining step, the viscoelastic mixture PTFE powder was extruded at the extrusion temperature of 80° C. into a rod shape.

Rolling Step

Then, the extrusion was rolled at 130° C. into a 300 mm wide and 0.7 mm thick sheet.

Folding Step

Then, the rolled sheet was triple-folded and passed through an oven at 260° C. into a 100 mm wide sheet having a three-layer structure.

Stretching Step

Then, the sheet was stretched through a first roller with 120% stretch ratio, through a second roller with 50% stretch ratio, through a third roller with 60% stretch ratio, through a fourth roller with 30% stretch ratio, and through a fifth roller with 15% stretch ratio, at the stretching temperature of 460° C.

Slit Step

The stretched sheet was cut into a 10 mm wide sheet.

Thread-Twisting Step

The cut tape was twisted into a mixture PTFE thread.

### Examples 8 and 9

A mixture PTFE powder having the same composition in a mixed PTFE emulsion as that in Example 1 except for water was used to produce a mixture PTFE thread under the conditions shown in Table 3 in which each condition in the manufacturing steps is different from that in Examples 1-7. Table 3 also shows the conditions in Examples 1-7.

TABLE 3

| | | Examples | Example | Example | Comparative | Comparative |
|---|---|---|---|---|---|---|
| | | 1-7 | 8 | 9 | Example 10 | Example 11 |
| Dispersing- | PTFE concentration | 20 | 10 | 25 | 20 | 20 |
| in-Water | in a PITE | | | | | |
| and Mixing | emulsion | | | | | |
| Step | Cake-like mixture | 160 | 120 | 190 | 90 | 250 |
| | Retention | | | | | |
| | temperature (° C.) | | | | | |
| | Cake-like mixture | 20 | 16 | 24 | 20 | 20 |
| | Retention time (Hour) | | | | | |
| Heat-retaining | Kerosene | 20 | 18 | 25 | 20 | 20 |
| Step | concentration (wt %) | | | | | |
| | Retaining | 40 | 30 | 50 | 40 | 40 |
| | temperature (° C.) | | | | | |
| | Retaining time (Hour) | 45 | 40 | 50 | 45 | 45 |
| Extrusion Step | Extrusion | 80 | 70 | 90 | 80 | 80 |
| | temperature (° C.) | | | | | |
| Rolling Step | Rod rolling | 130 | 100 | 150 | 130 | 130 |
| | temperature (° C.) | | | | | |
| Folding Step | Oven temperature | 260 | 250 | 270 | 260 | 260 |
| | allowing for | | | | | |
| | a triple-folded sheet | | | | | |
| | to pass through (° C.) | | | | | |
| Stretching | Stretching | 460 | 450 | 500 | 460 | 460 |
| Step | temperature | | | | | |

### Comparative Examples 1-9

A mixture PTFE powder having the same composition in a mixed PTFE emulsion as that in Example 1 except for water was prepared to produce a mixture PTFE thread under the same manufacturing conditions as those in Examples 1-7. Table 2 shows tensile strength of the produced mixture PTFE thread.

### Comparative Examples 10 and 11

A mixture PTFE powder having the same composition in a mixed PTFE emulsion as that in Example 1 except for water was used to produce a mixture PTFE thread under the conditions in which only the retention temperature of the cake-like mixture is different from that in Examples 1-7 and the other conditions are the same as those in Examples 1-7 among the conditions in the manufacturing steps (see Table 3). Table 2 shows tensile strength of the produced mixture PTFE thread.

### Comparative Examples 12-14

The manufacturing methods in Comparative Examples 12-14 are different from those in Examples and a mixture PTFE thread was produced under the following manufacturing conditions.

Dispersing Step

The PTFE solid content, MoS₂, Al₂O₃, and Al(OH)₃ were dispersed in water. Table 1 shows composition of the mixtures except for water.

Freeze-Drying Step

The dispersion liquid was freeze-dried under an ambient pressure of 10 mmHg at −40° C. into a powder paste.

Extrusion Step

The powder paste was extruded into a circular shape at 80° C.

Rolling Step

The extrusion in the extrusion step was rolled into a tape.

Stretching Step

The rolled tape was uniaxially stretched. Table 4 shows tensile strength.

TABLE 4

| | Thickness | Width | Cross Sectional | tensile |
|---|---|---|---|---|
| | (mm) | (mm) | Area (mm²) | strength (Mpa) |
| Comparative | 0.3 | 5 | 1.5 | 23.6 |
| Example 12 | | | | |
| Comparative | 0.6 | 3.5 | 2.1 | 17.8 |
| Example 13 | | | | |
| Comparative | 0.6 | 4 | 2.4 | 15.8 |
| Example 14 | | | | |
| Comparative | 0.4 | 12 | 4.8 | 12.1 |
| Example 15 | | | | |

### Comparative Example 15

As Comparative Example 15, a PTFE tape of GFO (registered trademark) manufactured by W. L. Gore & Associates Inc. was produced using raw materials of PTFE: 84 wt %, carbon black: 15 wt %, and silicone oil: 1 wt %. The tape was produced by the similar manufacturing methods to those in Comparative Examples 12-14 except for the raw materials. Table 4 shows tensile strength.

SEM Analysis.

In SEM observation, countless holes were observed in Comparative Example 15. All the holes were headed in the same direction and it is considered that the holes were uniaxially stretched. Few holes were observed in Example 1, and also many particles were observed on the surface. And they seemed to be aluminium oxide. It is believed that, in Example 1, aluminium oxide suppressed the stretch property of the thread and the thread became a network structure, leading to improvement in tensile strength.

Examples of the present invention showed very high tensile strength compared with Comparative Example 15 which is the conventional PTFE tape. In addition, Comparative Examples 12-14 in which the manufacturing conditions are different from those in the present invention but composition of the mixture PTFE powder is within the scope of the present invention also showed high tensile strength compared with Comparative Example 15 which is the conventional PTFE tape.

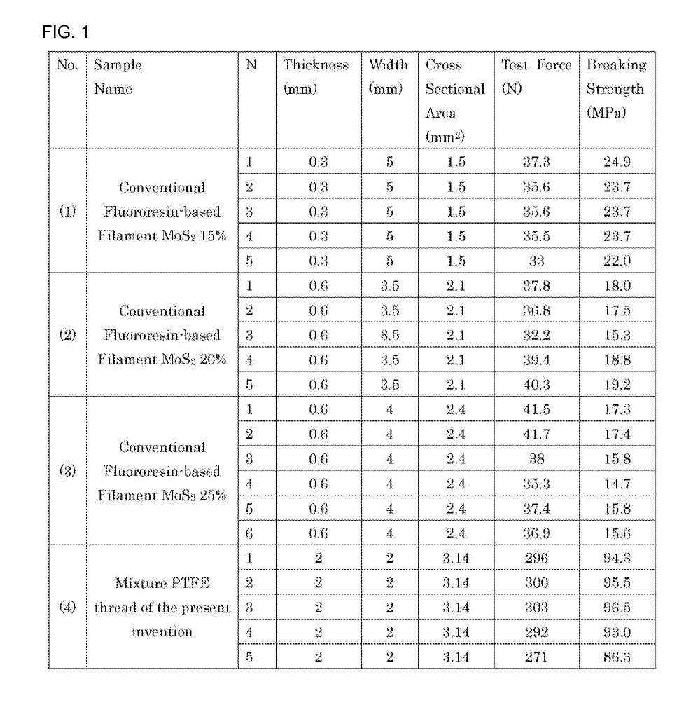

The mixture PTFE powder consisting of PTFE: 73-95 wt %, MoS₂: 3-25 wt %, Al₂O₃: 1-5 wt %, and Al(OH)₃: 1-5 wt % according to the present invention was compared with the conventional product with respect to breaking strength in accordance with the test method stipulated in JIS L1013 “Testing methods for man-made filament yarns”. FIG. 1 shows the test results.

Five mixture PTFE threads of the above-mentioned Example 1 was prepared (1-5 of No. (4) in FIG. 1). For convenience of implementation of the tests, we considered each test piece according to the present invention as having a circular cross section of 2 mm in diameter.

1-5 of No. (1) show a filament in which 15% of MoS₂ was combined into PTFE, 1-5 of No. (2) show a filament in which 20% of MoS₂ was combined into PTFE, and 1-6 of No. (3) show a filament in which 25% of MoS₂ was combined into PTFE. The mixture PTFE thread of the present invention had breaking strength 4 to 5 times greater than that of the conventional product.

The mixture PTFE thread of the present invention can be conveniently used in the fields of valves for various pumps, timing belts, V-belts, various petrochemical units, cars, airplanes, and rockets, as well as a gland packing.

### INDUSTRIAL APPLICABILITY

According to the present invention, provided are the manufacturing method of the mixture PTFE thread with excellent tensile strength which is applied to a gland packing, or a carbon fiber thread, a carbonized fiber thread, a chemical fiber thread such as an aramid fiber, or composite yarn with organic/inorganic materials, and the mixture PTFE thread with excellent tensile strength manufactured by the method which is used as materials such as a gland packing. Therefore, it can be applied in the fields of valves for various pumps, timing belts, V-belts, various petrochemical units, cars, airplanes, and rockets, as well as a gland packing.

1. A method of manufacturing a mixture PTFE thread using a mixture PTFE powder consisting of PTFE: 73-95 wt %, MoS₂: 3-25 wt %, Al₂O₃: 1-5 wt %, and Al(OH)₃: 1-5 wt %, the method comprising
heat-retaining step for adding 18-25 wt % kerosene of a solvent to the mixture PTFE powder and keeping it warm at 30-50° C. for 40 to 50 hours,
extruding the heat-retained mixture PTFE powder into a rod shape with a circular or elliptical cross section at the cylinder temperature of 70-90° C.,
rolling the extrusion at 100-150° C. into a 0.3-0.7 mm thick sheet shape,
multiple-folding the sheet and passing the sheet through an oven at 250-270° C. at the rate of 10-40 cm/s, and
stretching the folded sheet with a stretch ratio of 200-600% in multiple stages after heating the sheet at 450-500° C.

2. The method according to claim 1, wherein the multistage stretching is a five-stage stretching including first stretching with 120% stretch ratio, second stretching with 50% stretch ratio, third stretching with 60% stretch ratio, fourth stretching with 30% stretch ratio, and fifth stretching with 15% stretch ratio.

3. A mixture PTFE thread manufactured by the method according to claim 1, wherein the mixture PTFE thread has a diameter of 1-3 mm and a weight of 1-10 g/m.

4. A mixture PTFE thread manufactured by the method according to claim 2, wherein the mixture PTFE thread has a diameter of 1-3 mm and a weight of 1-10 g/m.
